(19) United States
(12) Patent Application Publication
(10) Pub. No.: US 2020/0216039 A1
(43) Pub. Date: Jul. 9, 2020

(54) SYSTEM AND METHOD FOR DRYING A VEHICLE USING A LAMINAR FLOW OF AIR

(71) Applicant: Thomas KIM, Elk Grove Village, IL (US)

(72) Inventor: Thomas KIM, Elk Grove Village, IL (US)

(21) Appl. No.: 16/733,189

(22) Filed: Jan. 2, 2020

Related U.S. Application Data
(60) Provisional application No. 62/787,513, filed on Jan. 2, 2019.

(51) Int. Cl. B60S 3/00; F26B 15/12; F26B 21/00; F26B 25/18

(52) U.S. Cl. CPC B60S 3/002; F26B 15/12; F26B 25/18; F26B 21/004; F26B 21/001

(57) ABSTRACT

A system for drying a vehicle with a laminar flow of air comprising a device for imparting a laminar flow of air from a pressurized plenum, a sensor for profiling the shape of the vehicle, and a control system that receives information on the profile of the vehicle from the sensor and controls the distance between the device and the vehicle while the device and vehicle move relative to one another. The distance between the vehicle and drying device is sufficient to maintain a laminar flow of air onto the surface of the vehicle from the pressurized plenum (D_{L}). A method of using the system is also disclosed.

### CROSS-REFERENCE TO RELATED APPLICATION

This application claims the benefit of priority to Provisional Application 62/787,513, filed Jan. 2, 2019. The entire contents of this application are expressly incorporated herein by reference.

### TECHNICAL FIELD

The present disclosure relates generally to a system for drying a vehicle, such as in a car wash, that uses a laminar flow of air. The present disclosure also relates to a method of drying a vehicle using the disclosed system.

### BACKGROUND

Traditional drying systems used in a car wash rely on forced air to blow off most of the moisture following a car wash. These systems rely on a turbulent flow of air from one or more overhead dryers that are often blowing water around in a random and inefficient manner. In such systems, conflicting airflows typically cancel each other by blowing water back onto areas previously dried. As a result, these systems can leave about 20% of the surface water on the vehicle, which must be removed by an employee of the car wash, wiped down by the customer, or air-dried as the customer drives away from the car wash.

To make matters worse, commercial air drying systems are noisy, expensive to operate and maintain. In addition, as they often rely on multiple 10 and 15 HP blowers located at the end of a car wash, a typical air drying system takes up a large footprint in most car washes, and uses a lot of energy.

As a result, there is a need for a smaller, more efficient and more economical system for drying a vehicle. The disclosed system for drying a vehicle and method of using it are directed to overcoming one or more of the problems set forth above and/or other problems of the prior art.

### SUMMARY

In one aspect, the present disclosure is directed a system for drying a vehicle with a laminar flow of air. The disclosed system comprises at least one device for imparting a laminar flow of air from a pressurized plenum, at least one sensor for profiling the shape of the vehicle, and a control system that receives information on the profile of the vehicle from the sensor and controls the distance between the device and the vehicle while the device and vehicle move relative to one another. The distance between the device and the vehicle is sufficient to maintain a laminar flow of air onto the surface of the vehicle from the pressurized plenum (D_{L}).

In another aspect, there is disclosed a method for drying a vehicle with a laminar flow of air. The disclosed method comprises an air drying system moving relative to a vehicle, where they move at a rate sufficient to remove water from the surface of the vehicle. In an embodiment, the system comprises at least device for imparting a laminar flow of air from a pressurized plenum, at least one sensor for profiling the shape of the vehicle, and a control system that receives information on the profile of the vehicle from the sensor and controls the distance between the device and the vehicle while the device and vehicle move relative to one another. As described, the distance is sufficient to maintain a laminar flow of air onto the surface of the vehicle from the pressurized plenum (D_{L}).

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is representation of a system for drying a vehicle with a laminar flow of air according to one embodiment of the present disclosure.

FIG. 2 is representation of a system for drying a vehicle with a laminar flow of air according to another embodiment of the present disclosure.

FIG. 3 is representation of a system for drying a vehicle with a laminar flow of air according to another embodiment of the present disclosure.

FIG. 4 is a representation of the profile of a vehicle determined prior to it entering the drying system described herein.

### DETAILED DESCRIPTION

### Definitions

As used herein, “air-knife,” which can also be called an “air-blade,” is a device that can produce a high-intensity, uniform sheet of laminar airflow, typically by pushing a pressurized air plenum through a series of holes or continuous slots.

As used herein, “a uniform sheet of laminar airflow” is sometimes referred to as a streamline flow.

As used herein, “drying zone” is the part of a car wash that is after the washing zone, and is dedicated to drying the vehicle, typically as the last part of the car wash process.

There are disclosed embodiments of systems for drying a vehicle with a laminar flow of air with enhanced performance and efficiency characteristics, and methods of using such a system. In an embodiment, there is disclosed a system that comprises at least one device for imparting a laminar flow of air from a pressurized plenum, at least one sensor for profiling the shape of the vehicle, and a control system that receives information on the profile of the vehicle from the sensor and controls the distance between the device and the vehicle while the device and vehicle move relative to one another. The distance between the device and the vehicle is sufficient to maintain a laminar flow of air onto the surface of the vehicle from the pressurized plenum (D_{L}).

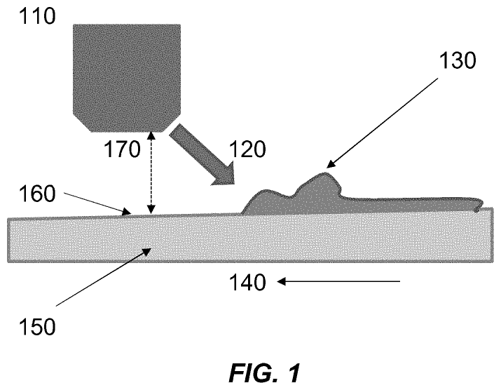

In an embodiment, the at least one sensor is attached to the device for imparting the pressurized plenum of air and provides real time feedback to the control system to adjust the device to the appropriate distance (D_{L}). With regard to this embodiment, reference is made to FIG. 1, which shows a system for drying a vehicle with a laminar flow of air. In this Figure, an air-knife 110 is maintained at a distance 170 from the surface of a vehicle 160 to provide a laminar flow of air 120 to the surface of the vehicle 160. The air flow pushes water 130 that is located on the surface of the vehicle 160 in a direction away from the air-knife.

This Figure also shows an example of the air-knife moving over the vehicle at a distance that keeps a laminar flow of air on the surface of the vehicle, which can happen in a number of ways. For example, the vehicle can remain static while the air-knife moves around the vehicle. In another embodiment, the air-knife can remain static in an x direction, relative to the vehicle (lateral direction) but does move in a y direction relative to the vehicle (horizontal direction) as the vehicle passes there-under. In addition, both the air-knife and vehicle may move in the same or in opposite directions. See, for example, FIG. 1, which shows the relative movement between the air-knife 110 and vehicle 150 is in opposite directions 140.

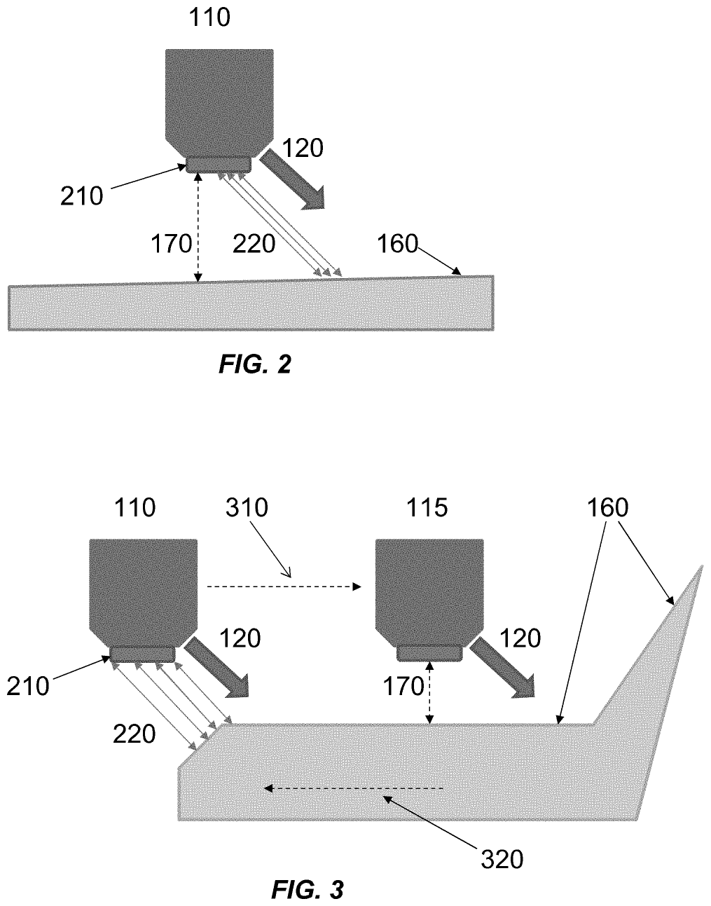

In an embodiment, there is a sensor that is intimately attached to the air-knife. With regard to this embodiment, reference is made to FIG. 2, which is substantially similar to the embodiment shown in FIG. 1, with the addition of a sensor 210 that is used for real-time measurement of the distance 170 between the air-knife and the surface of the vehicle 160. This embodiment shows a triangulation technique that is based on laser lines 220 impinging on the surface of the vehicle 160. As discussed in more detail below, a laser triangulation technique may be replaced or supplemented with a sonar technique that measures the profile of a vehicle prior to it entering the drying zone, and in some instances, prior to it entering the car wash.

FIG. 3 shows another embodiment that is similar to FIG. 2, further showing how the air-knife and vehicle move relative to one another from the initial position 110 to a subsequent position 115, while maintaining a laminar flow of air 120 on the surface of the vehicle 160. In an embodiment, the air-knife moves across the vehicle 310. In another embodiment, the vehicle moves in a direction 320 opposite the air-knife. As described herein, the movement of either the air-knife or the vehicle might be held in a fixed position while the other moves. Alternatively, both the air-knife and the vehicle can move until the vehicle is completely dried.

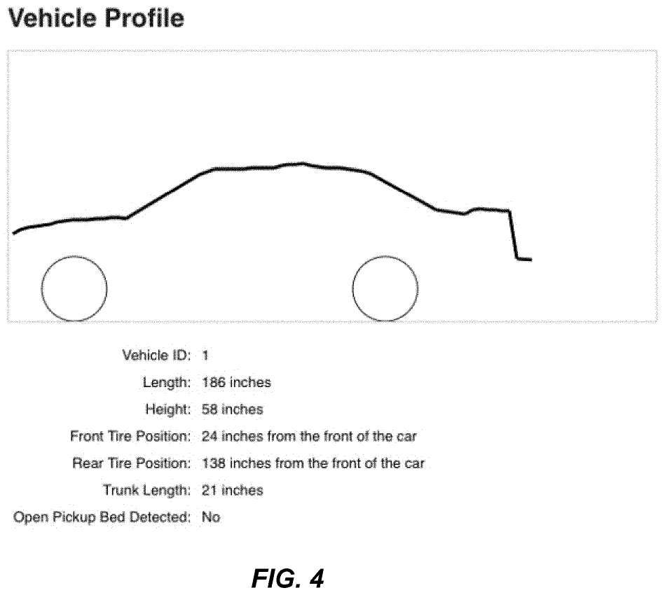

In an embodiment, the at least one sensor is located away from the drying system. Thus, unlike the embodiments shown in FIGS. 2 and 3, this embodiment utilizes a profile that is measured on the vehicle prior to the vehicle entering the drying zone. With regard to this embodiment, reference is made to FIG. 4, which shows a profile of the shape of the vehicle that is determined prior to the vehicle entering the drying zone or even entering the car wash. In one embodiment, the data on this profile can be saved and sent to a controller that controls the air-knife(s) in the drying system. Once the vehicle enters the drying zone, the stored profile adjusts the drying system to ensure a laminar flow of air impinges the surface of the vehicle.

In the embodiment in which data on a pre-measured profile is saved and sent to a controller that controls the air-knife(s) in the drying system, there is further described at least one sensor that provides feedback on the profiled shape to the control system. In this embodiment, the control system controls the device when the vehicle enters the drying zone.

In an embodiment, the least one sensor is part of a device that measures one or more of the following variables to determine the profile of the vehicle: height, width, length, windshield slope, and radius of curvature. Non-limiting examples of the types of systems that can be used to measure the profile of a vehicle include a laser triangulation or sonar based system.

In an embodiment, the device is a laser triangulation based system that further comprising at least one two-dimensional CCD detector array for viewing, at an angle, images of a laser lines that are emitted onto the surface of a vehicles.

In an embodiment, the device for imparting a laminar flow of air from a pressurized plenum comprises at least one air-knife or air-blade. One non-limiting example of the air-knife that can be used herein is the Dyson Airblade™.

Typical air-knives that can be used herein contain a series of holes or continuous slots less than 1.0 mm through which pressurized air exits in a laminar flow pattern for a predetermined distance, D_{L}. The series of holes in typical air-knives may have a shape selected from round, square, tear-drop, elongated oval, or combinations thereof.

In the system described herein, air exits the air-knife at a velocity sufficient to keep a laminar flow of air and needed to dry a vehicle using a flow of air that creates a squeegee type of effect to remove water. Such a velocity of air typically ranges from 10,000 to 60,000 FPM, such as 20,000 to 50,000 FPM, notably approximately 40,000 FPM.

The source for air pressure that is supplied to the air-knife includes an air compressor, blower motor, or other air manipulating device.

In one embodiment, the air knife described herein is configured to rotate to allow the laminar flow of air exiting the air knife to impinge on the surface of the vehicle at an angle ranging from 60 to 90 degrees, relative to the surface of the vehicle. In another embodiment, the air knife is configured to rotate to allow the laminar flow of air exiting the air knife to impinge on the surface of the vehicle at an angle ranging from 30 to 60 degrees, relative to the surface of the vehicle.

In another aspect of the disclosure, there is disclosed a method for drying a vehicle with a laminar flow of air. The disclosed method comprises a vehicle and an air drying system moving relative to one another at a rate sufficient to remove water from the surface of the vehicle. In an embodiment, the system comprises at least device for imparting a laminar flow of air from a pressurized plenum, at least one sensor for profiling the shape of said vehicle, and a control system that receives information on the profile of the vehicle from the sensor and controls the distance between the device and the vehicle while the device and vehicle move relative to one another. As described, the distance is sufficient to maintain a laminar flow of air (D_{L}) onto the surface of the vehicle from the pressurized plenum.

In the disclosed method, the at least one sensor is attached to the device for imparting the pressurized plenum of air and provides real time feedback to the control system to adjust the device to the appropriate distance (D_{L}).

In an alternate embodiment, the disclosed method comprises profiling the shape of the vehicle using at least one sensor prior to the vehicle entering the drying system. Whether it's a real-time feedback, or a pre-measured profile, the at least one sensor provides feedback on the profiled shape to the control system that is used to adjust the distance between the vehicle and device when the vehicle enters the drying system. For example, the sensor uses a laser triangulation measurement or sonar to measure one or more of the following variables to determine the profile of the vehicle: height, width, length, windshield slope, and radius of curvature.

When the method comprises a laser triangulation system, a CCD detector array for viewing images of laser lines that are emitted onto the surface of said vehicle may also be used. Whatever technique is used, the goal is to keep a sufficient distance between the air-knife and vehicle to allow a laminar flow of air from a pressurized plenum coming from the air-knife.

Other factors that could affect the distance include the shape and size of holes or continuous slots on the air-knife. They are typically less than 1.0 mm to allow pressurized air to exits in a laminar flow pattern at a velocity ranging from 10,000 to 60,000 FPM, such as 20,000 to 50,000 FPM, notably about 40,000 FPM.

In an embodiment, the source for air pressure comprises an air compressor, blower motor, or other air manipulating device.

To ensure various topographies can be easily dried, the disclosed system should allow the air knife to rotate at an angle ranging from 60 to 90 degrees, relative to the surface of the vehicle, or at an angle ranging from 30 to 60 degrees, relative to the surface of the vehicle.

As previously indicated, the system described herein can be configured multiple different ways to allow the drying system to move relative to the vehicle it is drying. For example, the vehicle can remain held in a static position while the air-knife moves around the vehicle.

In another embodiment, the method may comprise maintaining the at least one device for imparting a laminar flow of air fixed in the x direction, relative to the vehicle while moving it in a y direction relative to the vehicle as the vehicle passes there-under.

In yet another embodiment, the method may comprise moving both the air-knife and vehicle in the same direction, in opposite directions, or in a combination of both, until the vehicle is sufficiently dried.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the invention will be apparent to those skilled in the art from consideration of the specification and practice of the invention disclosed herein. It is intended that the specification and examples be considered as exemplary only, with the true scope of the invention being indicated by the following claims.

1. A system for drying a vehicle with a laminar flow of air, said system comprising:
at least one device for imparting a laminar flow of air from a pressurized plenum;
at least one sensor for profiling the shape of said vehicle; and
a control system that receives information on the profile of the vehicle from the sensor and controls the distance between the device and the vehicle while the device and vehicle move relative to one another, wherein said distance is sufficient to maintain a laminar flow of air onto the surface of the vehicle from the pressurized plenum (D_{L}).

2. The system of claim 1, wherein said at least one sensor is attached to the device for imparting the pressurized plenum of air and provides real time feedback to the control system to adjust the device to the appropriate distance (D_{L}).

3. The system of claim 1, wherein said at least one sensor is located at away from the said at least one device and is able to profile the shape of the vehicle prior to the vehicle entering the drying system, wherein the at least one sensor provides feedback on the profiled shape to the control system, which the control system uses to control said device when the vehicle enters the drying system.

4. (canceled)

5. The system of claim 3, wherein said at least one sensor uses is part of a device that measures one or more of the following variables to determine the profile of the vehicle: height, width, length, windshield slope, and radius of curvature.

6. The system of claim 5, wherein the device comprises a laser triangulation or sonar based system, wherein when the device is a laser triangulation based system it further comprising at least one two-dimensional CCD detector array for viewing, at an angle, images of a laser lines that are emitted onto the surface of a vehicles.

7. (canceled)

8. The system of claim 1, wherein the device for imparting a laminar flow of air from a pressurized plenum comprises at least one air-knife, wherein the wherein air exists the air-knife at a velocity ranging from 4,000-60,000 FPM.

9. The system of claim 8, wherein the air-knife contains a series of holes or continuous slots less than 1.0 mm through which pressurized air exits in a laminar flow pattern for a predetermined distance, D_{L}, wherein the series of holes have a shape selected from round, square, tear-drop, elongated oval, or combinations thereof.

10. (canceled)

11. (canceled)

12. The system of claim 8, wherein the air knife is configured to rotate to allow the laminar flow of air exiting the air knife to impinge on the surface of the vehicle at an angle ranging from 30 to 90 degrees, relative to the surface of the vehicle.

13. (canceled)

14. (canceled)

15. The system of claim 1, wherein the at least one device for imparting a laminar flow of air is configured to move around a vehicle that is held in a static position.

16. (canceled)

17. The system of claim 1, wherein both the air-knife and vehicle move in the same direction, in opposite directions, or in a combination of both, until the vehicle is sufficiently dried.

18. A method for drying a vehicle with a laminar flow of air, said method comprising:
a vehicle and air drying system move relative to one another at a rate sufficient to remove water from the surface of the vehicle, the system comprising:
at least device for imparting a laminar flow of air from a pressurized plenum;
at least one sensor for profiling the shape of said vehicle; and
a control system that receives information on the profile of the vehicle from the sensor and controls the distance between the device and the vehicle while the device and vehicle move relative to one another, wherein said distance is sufficient to maintain a laminar flow of air onto the surface of the vehicle from the pressurized plenum (D_{L}).

19. The method of claim 18, wherein said at least one sensor is attached to the device for imparting the pressurized plenum of air and provides real time feedback to the control system to adjust the device to the appropriate distance (D_{L}).

20. The method of claim 18, wherein said method comprises profiling the shape of the vehicle using at least one sensor prior to the vehicle entering the drying system, wherein the at least one sensor provides feedback on the profiled shape to the control system that is used to adjust the distance between the vehicle and device when the vehicle enters the drying system.

21. (canceled)

22. The method of claim 18, wherein said at least one sensor uses a laser triangulation measurement or sonar to measure one or more of the following variables to determine the profile of the vehicle: height, width, length, windshield slope, and radius of curvature.

23. The method of claim 22, wherein the sensor uses a laser triangulation system that further includes a CCD detector array that views images of laser lines that are emitted onto the surface of said vehicle.

24. The method of claim 18, wherein the device for imparting a laminar flow of air from a pressurized plenum comprises at least one air-knife.

25. The method of claim 24, wherein the air-knife contains a series of holes or continuous slots less than 1.0 mm through which pressurized air exits in a laminar flow pattern at a velocity ranging from 4,000-60,000 FPM.

26. (canceled)

27. (canceled)

28. The method of claim 18, further comprising rotating the air knife to allow the laminar flow of air exiting the air knife to impinge on the surface of the vehicle at an angle ranging from 30 to 90 degrees, relative to the surface of the vehicle.

29. (canceled)

30. The method of claim 18, comprising moving the at least one device for imparting a laminar flow of air around a vehicle that is held in a static position.

31. (canceled)

32. The method of claim 18, comprising moving both the air-knife and vehicle in the same direction, in opposite directions, or in a combination of both, until the vehicle is sufficiently dried.
